(19) United States
(12) Patent Application Publication
(10) Pub. No.: US 2018/0059307 A1
(43) Pub. Date: Mar. 1, 2018

(54) Novel Light Guide Plate Lamp

(71) Applicant: Zhongshan Winstar Electrical Co., Ltd., Zhongshan (CN)

(72) Inventors: Yu Li, Zhongshan (CN); Nan Chun Chen, Zhongshan (CN); Feng Du, Zhongshan (CN); Hui Liang Xin, Zhongshan (CN)

(21) Appl. No.: 15/385,848

(22) Filed: Dec. 20, 2016

(30) Foreign Application Priority Data
Aug. 31, 2016 (CN) 201621014152.8

(51) Int. Cl. F21V 8/00

(52) U.S. Cl. CPC G02B 6/0031; G02B 6/0083; G02B 6/0086

(57) ABSTRACT

The present invention discloses a novel light guide plate lamp. A light guide plate is disposed at an opening of a casing, a bottom reflective surface is disposed between the bottom of the casing and the light guide plate, and lateral reflective surfaces are disposed between the lateral surfaces of the casing and the lateral surfaces of the light guide plate. A part of light generated by the lamp beads is reflected by an arc-shaped or inclined lateral reflective surface onto the bottom reflective panel and the other lateral reflective surface, which eventually shoots out from the light guide plate at the opening of the casing after refraction and reflection. As a result, the lamp of the present invention has uniform and soft light emergence and no dazzling. Meanwhile this structural design is simple and reasonable, allowing convenience of manufacture and assembly, which may lower manufacturing cost.

### CROSS REFERENCE TO RELATED APPLICATIONS

The present application claims the benefit of Chinese Patent Application No. 201621014152.8 filed on Aug. 31, 2016. All the above are hereby incorporated by reference.

### TECHNICAL FIELD OF THE INVENTION

The present invention relates to lighting devices, and more particularly, to a novel light guide plate lamp.

### BACKGROUND OF THE INVENTION

In the market, there are a great variety of lighting lamps with various structures. Strip lights and night lights are popular. They give out light through lamp beads and the light shoots out directly through a light guide plate and/or a lampshade. This way of light emergence features high and uneven brightness and is liable to dazzling, affecting user's eyes.

The present invention is aimed to address the problem of the prior art.

### SUMMARY OF THE INVENTION

The object of the invention is to solve the above technical problem, and provides a novel light guide plate lamp. A light guide plate is disposed at an opening of a casing, a bottom reflective surface is disposed between the bottom of the casing and the light guide plate, lateral reflective surfaces are disposed between the lateral surfaces of the casing and the lateral surfaces of the light guide plate, and lamp beads are disposed along an inner bottom edge of the casing, the lateral reflective surface near the lamp beads is in an arc-shaped or inclined plane, a part of light generated by the lamp beads is reflected by an arc-shaped or inclined lateral reflective surface onto the bottom reflective surface and the other lateral reflective surface, and after refraction and reflection, light eventually shoots out from the light guide plate at the opening of the casing. As a result, the lamp of the present invention has uniform and soft light emergence and no dazzling. Meanwhile this structural design is simple and reasonable, allowing convenience of manufacture and assembly, which may lower manufacturing cost.

In order to solve the foregoing technical problem, the present invention provides a novel light guide plate lamp, comprising:

a casing having an opening at least on one side;

a light guide plate disposed at the opening of the casing;

a light-emitting element having lamp beads, which is disposed at inner bottom of the casing and between the casing and the light guide plate;

wherein the lamp beads are arranged along an edge of the inner bottom of the casing, and a bottom reflective surface is disposed between bottom of the casing and bottom of the light guide plate;

and wherein lateral reflective surfaces are disposed between lateral surfaces of the casing and lateral surfaces of the light guide plate, and at least the lateral reflective surface near the lamp beads is in an arc-shaped or inclined plane.

Preferably, the lateral reflective surfaces and the bottom reflective surface are made of reflective paper, and the reflective paper is disposed between the casing and the light guide plate.

Preferably, the lateral reflective surfaces and the bottom reflective surface are made of reflective coating.

Preferably, the casing and the light guide plate are both shaped as a revolved body, and the lateral reflective surfaces are in an arc-shaped or inclined plane.

Preferably, the casing and the light guide plate are both in a strip-shaped structure; and one end of the casing is provided with a port which is connected to an end cover for fixing the light-emitting element and the light guide plate relative to the casing; and wherein the lamp beads are arranged along an edge of the inner bottom of the casing in a length direction, and correspondingly, the lateral reflective surface near the lamp beads is in an arc-shaped or inclined plane.

Preferably, the casing and the light guide plate are both shaped as a strip structure; and one end of the casing is provided with a port which is connected to an end cover for fixing the light-emitting element and the light guide plate relative to the casing; and wherein the lamp beads are arranged along two edges of the inner bottom of the casing in a length direction, and correspondingly, the lateral reflective surfaces formed on two inner lateral surfaces between the casing and the light guide plate in a length direction are both in an arc-shaped or inclined plane.

Compared with the prior art, the novel light guide plate provided by the present invention has the following advantages:

1. the lateral reflective surfaces and the bottom reflective surface are disposed between the lateral surfaces and bottoms of the light guide plate and the casing, and the lateral reflective surface near the lamp beads are in an arc-shaped or inclined plane, which may allow that a part of light generated by the lamp beads is reflected by an arc-shaped or inclined lateral reflective surface onto the bottom reflective surface and the other lateral reflective surface, and after refraction and reflection, light eventually shoots out from the light guide plate at the opening of the casing. As a result, the implementation of the present invention may obtain uniform and soft light emergence and no dazzling.

2. The structure adopting the foregoing design may result in simple and reasonable structure, allowing convenience of manufacture and assembly, which may lower manufacturing cost.

### BRIEF DESCRIPTION OF THE DRAWINGS

Below specific embodiments of the present invention are further described in details by referring to the accompanying drawings, wherein:

FIG. 1 is a schematic view of the present invention;

FIG. 2 is a schematic view of the present invention;

FIG. 3 is sectional view taken along line A-A of FIG. 2;

FIG. 4 is an exploded view of the present invention;

FIG. 5 is an exploded view of the present invention;

FIG. 6 is a schematic view of a casing in the present invention;

FIG. 7 is a top view of an alternative embodiment of the present invention; and

FIG. 8 is a sectional view of an alternative embodiment of the present invention.

### DETAILED DESCRIPTION OF THE INVENTION

The present invention is set forth in detail herein with reference to the accompanying drawings.

The present invention provides a novel light guide plate lamp comprising a casing 1 having an opening at least on one side. A light guide plate 2 is disposed at the opening of the casing 1. A light-emitting element 3 with lamp beads 31 is disposed at the inner bottom of the casing 1 and between the casing 1 and the light guide plate 2. The light-emitting element 3 comprises a control circuit board and a corresponding sensor. The lamp beads 31 are arranged along an edge of the inner bottom of the casing 1. A bottom reflective surface 5 is disposed between the bottom of the casing 1 and the bottom of the light guide plate 2. Lateral reflective surfaces 4 are disposed between the lateral surfaces of the casing 1 and the lateral surfaces of the light guide plate 2, and at least the lateral reflective surface 4 near the lamp beads 31 is in an arc-shaped or inclined plane. Part of the light generated by the lamp beads 31 is reflected by the arc-shaped or inclined lateral reflective surface on the bottom reflective surface and the other lateral reflective surface, and after refraction and reflection, light eventually shoots out from the light guide plate 2 at the opening of the casing 1 to avoid direct emergence of the light generated by the lamp beads 31, allowing that implementation of the present invention may obtain uniform and soft light emergence and no dazzling.

The lateral reflective surfaces 4 and the bottom reflective surface 5 are made of reflective paper. The reflective paper is disposed between the casing 1 and the light guide plate 2. When reflective paper is used, through holes that allow the lamp beads 31 to pass through are disposed on the reflective paper. The reflective paper is pasted on the inner lateral surfaces of the casing 1, or on the inclined surfaces of the lateral surfaces of the light guide plate 2.

Alternatively, the lateral reflective surfaces 4 and the bottom reflective surface 5 are made of reflective coating. Likewise, the reflective coating is coated on the inner lateral surfaces of the casing 1, or on the inclined surfaces of the lateral surfaces of the light guide plate 2.

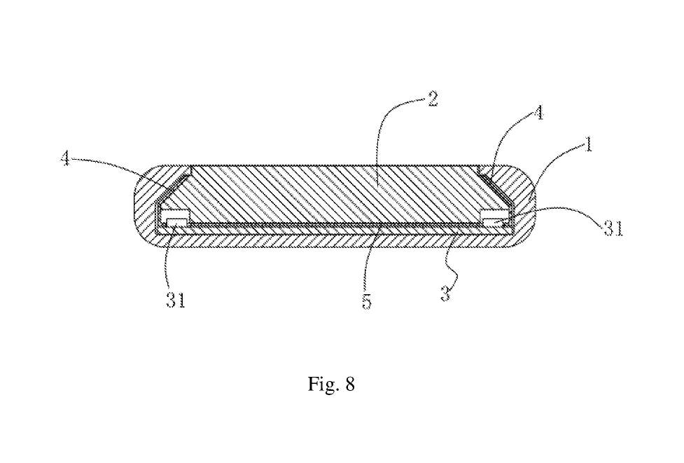

As shown in FIG. 7 and FIG. 8, in one embodiment of the present invention, the casing 1 and the light guide plate 2 are shaped as a revolved body, and the lateral reflective surfaces 4 are in an arc-shaped or inclined plane.

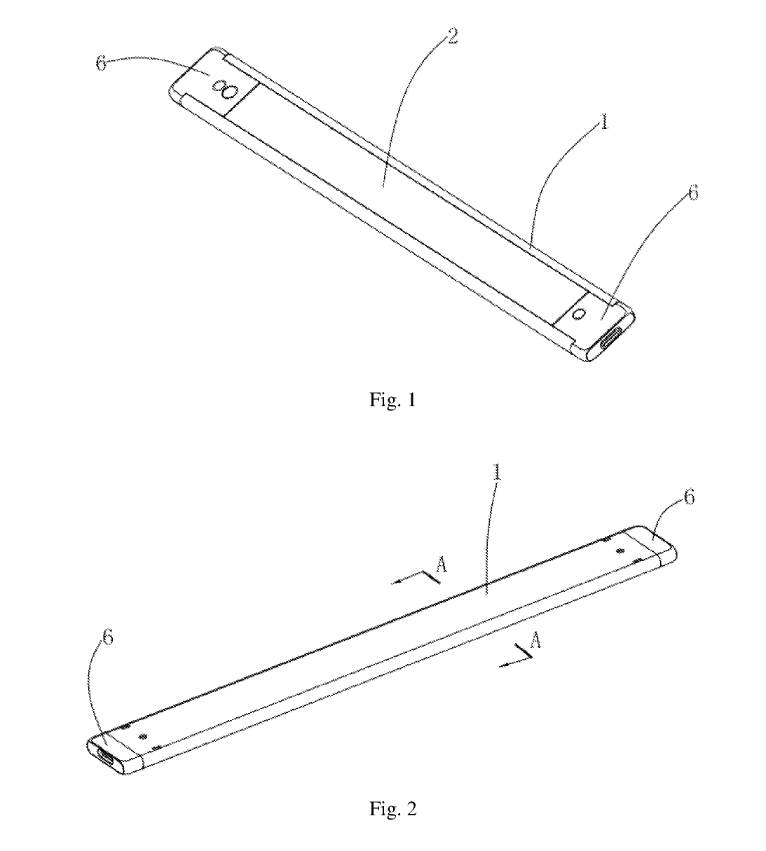

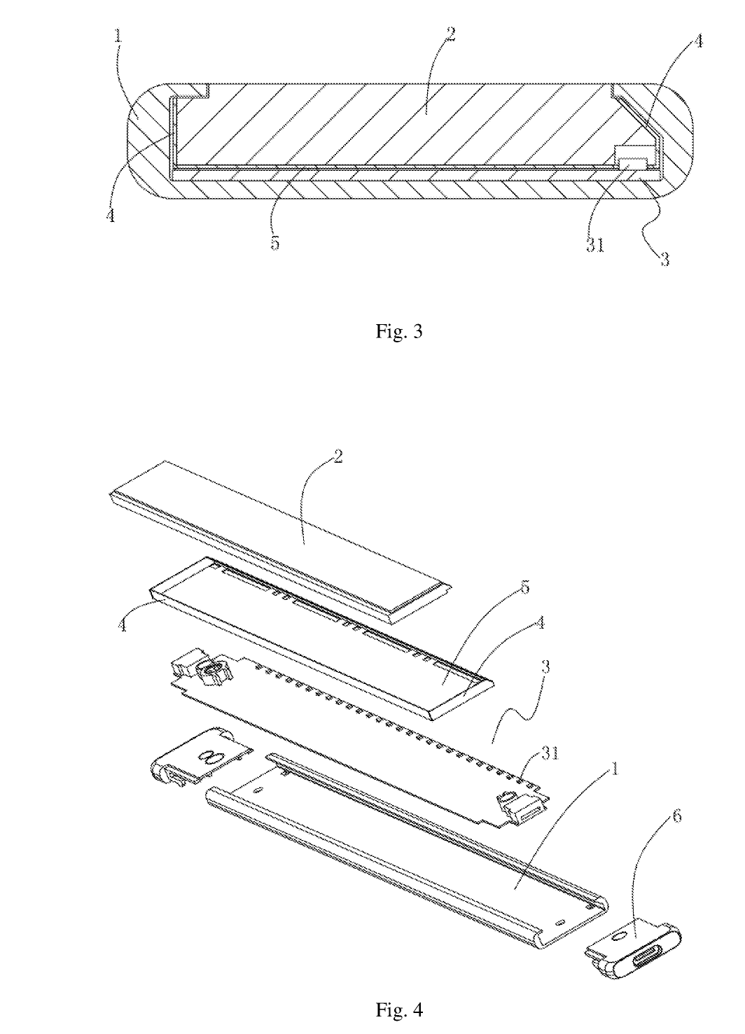

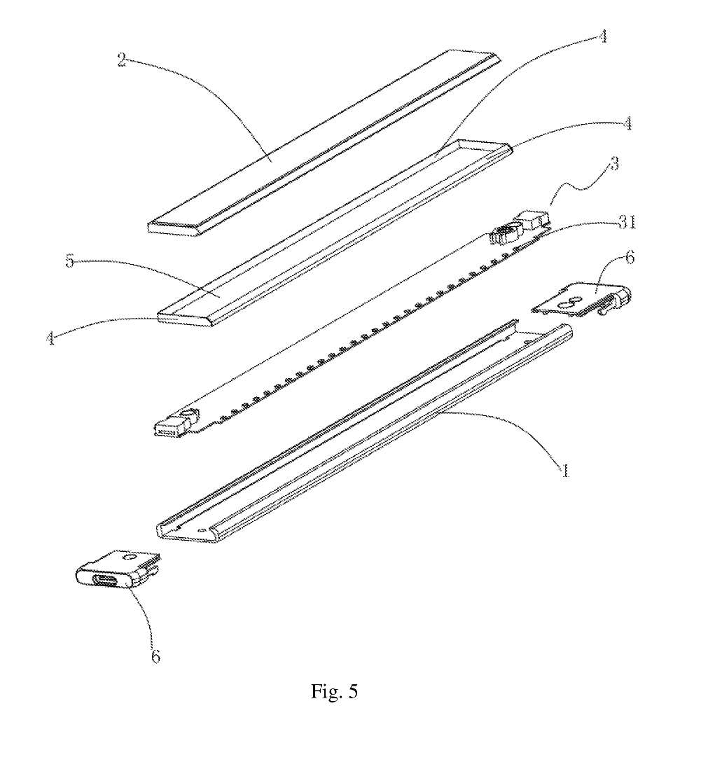

As shown in FIG. 1˜FIG. 5, in an alternative embodiment of the present invention, the casing 1 and the light guide plate 2 are both in a strip-shaped structure, and a port is disposed at one end of the casing 1, and an end cover 6 for fixing the light-emitting element 3 and the light guide plate 2 relative to the casing 1 is connected to the port of the casing 1. An inductive control switch electrically connected to the light-emitting element 3 is disposed on the end cover 6. The lamp beads 31 are arranged along an edge of the inner bottom of the casing in a length direction, i.e.: the lamp beads 31 are arranged in a line shape along one edge of the casing. Correspondingly, the lateral reflective surface 4 near the lamp beads 31 is in an arc-shaped or inclined plane, while the other lateral reflective surface 4 opposite to this lateral reflective surface 4 may also be an arc-shaped surface, or an inclined surface, or a vertical surface.

Alternatively, the casing 1 and the light guide plate 2 are both in a strip-shaped structure, and a port is arranged at one end of the casing 1, and an end cover 6 for fixing the light-emitting element 3 and the light guide plate 2 relative to the casing 1 is connected to the port of the casing 1. An inductive control switch electrically connected to the light-emitting element 3 is disposed on the end cover 6. The lamp beads 31 are arranged along two edges of the inner bottom of the casing 1 in a length direction. Correspondingly, the lateral reflective surfaces 4 formed on the two inner lateral surfaces between the casing 1 and the light guide plate 2 in a length direction are in an arc-shaped or an inclined plane.

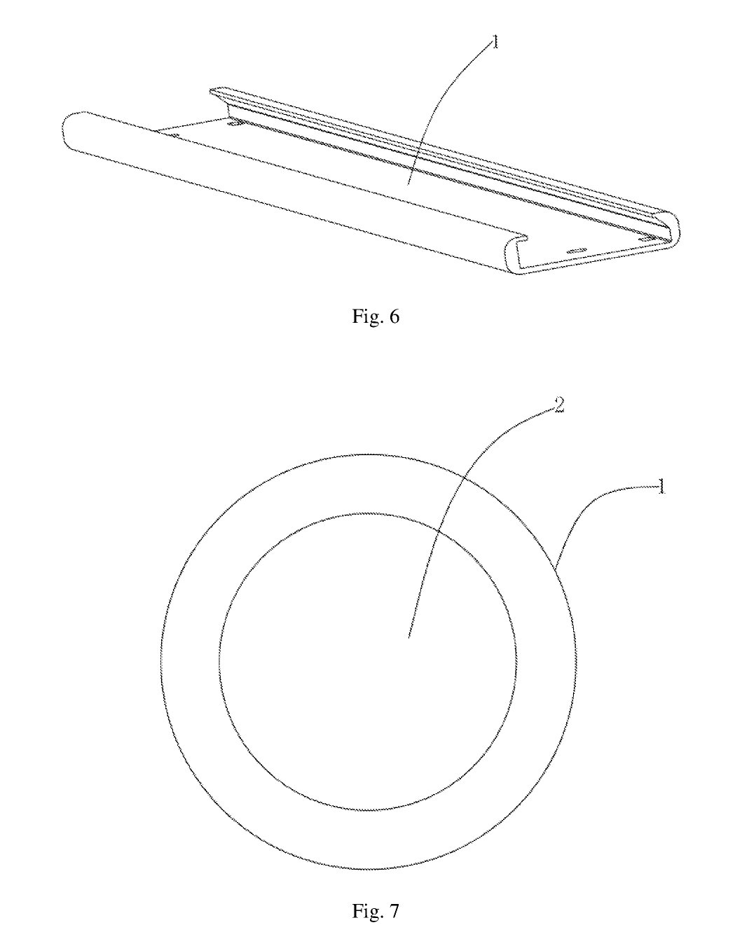

As shown in FIG. 6, the light guide plate 1 and the light-emitting element 3 are secured on the casing 1 by the end cover 6 of the two ends of the casing 1, and a groove is formed on the two inner sides of the casing 1, by which the light guide plate 2 is inserted into the casing 1.

It is to be understood that the foregoing features and principles of this invention are merely descriptive, and that many departures and variations thereof are possible by those skilled in the art, without departing from the spirit and scope of the invention.

What is claimed is:

1. A novel light guide plate lamp comprising:
a casing having an opening at least on one side;
a light guide plate disposed at the opening of the casing;
a light-emitting element having lamp beads, which is disposed at inner bottom of the casing and between the casing and the light guide plate;
wherein the lamp beads are arranged along an edge of the inner bottom of the casing, and a bottom reflective surface is disposed between bottom of the casing and bottom of the light guide plate;
and wherein lateral reflective surfaces are disposed between lateral surfaces of the casing and lateral surfaces of the light guide plate, and at least the lateral reflective surface near the lamp beads is in an arc-shaped or inclined plane.

2. The lamp according to claim 1, wherein the lateral reflective surfaces and the bottom reflective surface are made of reflective paper, and the reflective paper is disposed between the casing and the light guide plate.

3. The lamp according to claim 1, wherein the lateral reflective surfaces and the bottom reflective surface are made of reflective coating.

4. The lamp according to claim 1, wherein the casing and the light guide plate are both shaped as a revolved body, and the lateral reflective surfaces are in an arc-shaped or inclined plane.

5. The lamp according to claim 2, wherein the casing and the light guide plate are both shaped as a revolved body, and the lateral reflective surfaces are in an arc-shaped or inclined plane.

6. The lamp according to claim 3, wherein the casing and the light guide plate are both shaped as a revolved body, and the lateral reflective surfaces are in an arc-shaped or inclined plane.

7. The lamp according to claim 1, wherein the casing and the light guide plate are both in a strip-shaped structure; and one end of the casing is provided with a port which is connected to an end cover for fixing the light-emitting element and the light guide plate relative to the casing; and wherein the lamp beads are arranged along an edge of the inner bottom of the casing in a length direction, and correspondingly, the lateral reflective surface near the lamp beads is in an arc-shaped or inclined plane.

8. The lamp according to claim 2, wherein the casing and the light guide plate are both in a strip-shaped structure; and one end of the casing is provided with a port which is connected to an end cover for fixing the light-emitting element and the light guide plate relative to the casing; and wherein the lamp beads are arranged along an edge of the inner bottom of the casing in a length direction, and correspondingly, the lateral reflective surface near the lamp beads is in an arc-shaped or inclined plane.

9. The lamp according to claim 3, wherein the casing and the light guide plate are both in a strip-shaped structure; and one end of the casing is provided with a port which is connected to an end cover for fixing the light-emitting element and the light guide plate relative to the casing; and wherein the lamp beads are arranged along an edge of the inner bottom of the casing in a length direction, and correspondingly, the lateral reflective surface near the lamp beads is in an arc-shaped or inclined plane.

10. The lamp according to claim 1, wherein the casing and the light guide plate are both shaped as a strip structure; and one end of the casing is provided with a port which is connected to an end cover for fixing the light-emitting element and the light guide plate relative to the casing; and wherein the lamp beads are arranged along two edges of the inner bottom of the casing in a length direction, and correspondingly, the lateral reflective surfaces formed on two inner lateral surfaces between the casing and the light guide plate in a length direction are both in an arc-shaped or inclined plane.

11. The lamp according to claim 2, wherein the casing and the light guide plate are both shaped as a strip structure; and one end of the casing is provided with a port which is connected to an end cover for fixing the light-emitting element and the light guide plate relative to the casing; and wherein the lamp beads are arranged along two edges of the inner bottom of the casing in a length direction, and correspondingly, the lateral reflective surfaces formed on two inner lateral surfaces between the casing and the light guide plate in a length direction are both in an arc-shaped or inclined plane.

12. The lamp according to claim 3, wherein the casing and the light guide plate are both shaped as a strip structure; and one end of the casing is provided with a port which is connected to an end cover for fixing the light-emitting element and the light guide plate relative to the casing; and wherein the lamp beads are arranged along two edges of the inner bottom of the casing in a length direction, and correspondingly, the lateral reflective surfaces formed on two inner lateral surfaces between the casing and the light guide plate in a length direction are both in an arc-shaped or inclined plane.
